(19) United States
(12) Patent Application Publication
(10) Pub. No.: US 2015/0339088 A1
(43) Pub. Date: Nov. 26, 2015

(54) HISTORY STORAGE DEVICE, IMAGE FORMING APPARATUS AND NON-TRANSITORY COMPUTER READABLE MEDIUM STORING PROGRAM

(71) Applicant: FUJI XEROX CO., LTD., Tokyo (JP)

(72) Inventors: Masayuki KUDO, Kanagawa (JP); Keiji ISHIGURO, Kanagawa (JP); Atsuo MATSUNAGA, Kanagawa (JP); Masashi MURAKAMI, Kanagawa (JP); Atsuhiro ITO, Kanagawa (JP)

(73) Assignee: FUJI XEROX CO., LTD., Tokyo (JP)

(21) Appl. No.: 14/513,926

(22) Filed: Oct. 14, 2014

(30) Foreign Application Priority Data
May 21, 2014 (JP) 2014-105010

(51) Int. Cl. G06F 3/12; G06K 15/00

(52) U.S. Cl. CPC G06F 3/1273; G06K 15/005; G06K 15/408; G06F 3/121; G06F 3/1203; G06F 3/1229

(57) ABSTRACT

A history storage device includes: a storage part that stores information; a device status information obtaining unit that obtains device status information related to a status of an image forming apparatus in forming an image, the image forming apparatus including an image forming part that forms the image corresponding to an image forming instruction; and an association unit that, when the image forming instruction satisfies a preset condition, associates the image forming instruction with the device status information obtained by the device status information obtaining unit when the image corresponding to the image forming instruction is formed, and causes the storage part to store the associated image forming instruction and device status information.

### CROSS REFERENCE TO RELATED APPLICATION

This application is based on and claims priority under 35 USC §119 from Japanese Patent Application No. 2014-105010 filed May 21, 2014.

### BACKGROUND

1. Technical Field

The present invention relates to a history storage device, an image forming apparatus and a non-transitory computer readable medium storing a program.

2. Related Art

When an abnormal operation (error operation) occurs in forming an image, some image forming apparatuses store details of the error or the date and time of the occurrence of the error as an error log.

### SUMMARY

According to an aspect of the present invention, there is provided a history storage device including: a storage part that stores information; a device status information obtaining unit that obtains device status information related to a status of an image forming apparatus in forming an image, the image forming apparatus including an image forming part that forms the image corresponding to an image forming instruction; and an association unit that, when the image forming instruction satisfies a preset condition, associates the image forming instruction with the device status information obtained by the device status information obtaining unit when the image corresponding to the image forming instruction is formed, and causes the storage part to store the associated image forming instruction and device status information.

### BRIEF DESCRIPTION OF THE DRAWINGS

An exemplary embodiment of the present invention will be described in detail based on the following figures, wherein:

FIG. 1 is a block diagram showing a configuration of a printer (an example of an image forming apparatus) related to an exemplary embodiment according to the present invention;

FIG. 2 is a diagram showing an example of a screen for setting conditions displayed in an accepting part;

FIG. 3 is a diagram showing another example of a screen for setting conditions displayed in a receiving part;

FIGS. 4-1 and 4-2 are flowcharts showing operations of the printer; and

FIG. 5 is a diagram showing an example of a hardware configuration that implements a function of a history storage device by a computer having read a program.

### DETAILED DESCRIPTION

Hereinafter, an exemplary embodiment according to the present invention will be described in detail with reference to attached drawings.

### <Basic Configuration of Printer 10>

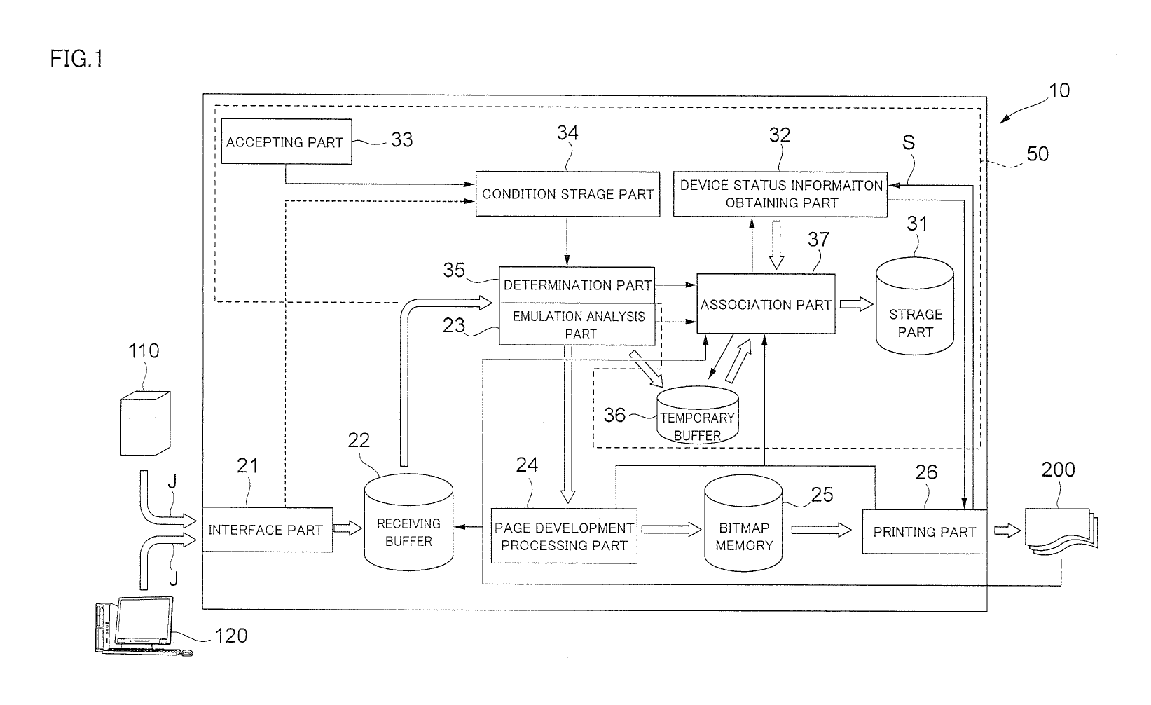

FIG. 1 is a block diagram showing a configuration of a printer 10 (an example of an image forming apparatus) related to an exemplary embodiment according to the present invention. In the figure, a hollow arrow indicates a flow of data, and a normal arrow indicates a control signal or a flow of information.

The printer 10 shown in the figure includes: an interface part 21 that is connected to an external large-sized computer 110 or a client personal computer (hereinafter, referred to as a client PC) 120 to receive input of a print job J (an example of an image forming instruction); and a receiving buffer 22 that stores the print job J inputted through the interface part 21. Moreover, the printer 10 also includes: an emulation analysis part 23 that analyzes emulation of print data in the print job J stored in the receiving buffer 22; and a page development processing part 24 that converts the print data into bitmap image data interpretable by a printing part 26, to be described later, based on the analyzed emulation. The printer 10 further includes: a bitmap memory 25 on which the bitmap image data converted in the page development processing part 24 is developed; and the printing part 26 (an example of an image forming part) that prints an image corresponding to the bitmap image data developed on the bitmap memory 25 onto a sheet 200 specified by the print job J.

According to the above-described basic configuration of the printer 10, the print job J requested from the external large-sized computer 110 or the client PC 120 is inputted to the receiving buffer 22 through the interface part 21 by communication via a network or the like. The emulation analysis part 23 of the printer 10 analyzes the emulation in the print data of the print job J stored in the receiving buffer 22.

The page development processing part 24 of the printer 10 converts the print data into the bitmap image data based on the analyzed emulation, and develops the bitmap image data obtained by the conversion onto the bitmap memory 25. The printing part 26 prints the image corresponding to the bitmap image data developed on the bitmap memory 25 onto the sheet 200.

### <Configuration of History Storage Device 50>

Other than the above-described basic configuration for printing process, the printer 10 includes a configuration of the history storage device 50 that stores specific history information in the printing process.

In other words, the printer 10 includes: a storage part 31 that stores history information; and a device status information obtaining part 32 (an example of a device status information obtaining unit) that obtains device status information S related to a status of the printer 10 in printing an image. Here, the device status information S is mechanical information mainly related to mechanics, mechanism, components or the like of the printer 10. Specific examples of the device status information S include: information that specifies a state of consumption of a consumable part such as toner; information that specifies a state of detection of each mechanical sensor; information that specifies each setting state on a mechanical side; and information that specifies the latest status of the printer 10 when the device status information S is obtained. The latest device status information S is obtained every time the information is stored.

Moreover, the printer 10 includes: an accepting part 33 that accepts input of conditions for the print job J, of details stipulated by the print job J, corresponding to history information which a user desires to cause the storage part 31 to store; and a condition storage part 34 that stores the conditions inputted to the accepting part 33.

The printer 10 further includes: a determination part 35 that determines whether or not the print job J stored in the receiving buffer 22 satisfies the conditions stored in the condition storage part 34; and a temporary buffer 36 (a temporary storage part) that temporarily stores the print job J determined by the determination part 35 to satisfy the conditions. Moreover, the printer 10 includes an association part 37. When a series of printing process, which is from the analyzing process of the emulation in the print job J determined by the determination part 35 to satisfy the conditions to completion of printing of the image corresponding to the print job J, is executed, the association part 37 associates the print job J stored in the temporary buffer 36 with the device status information S obtained by the device status information obtaining part 32, and stores as history information in the storage part 31.

Then, the history storage device 50 is configured with these components, namely, the storage part 31, the device status information obtaining part 32, the accepting part 33, the condition storage part 34, the determination part 35, the temporary buffer 36 and the association part 37.

It should be noted that the association part 37 associates the print job J stored in the temporary buffer 36 with the device status information S and causes the storage part 31 to store the associated print job J and device status information S, and thereafter, deletes the print job J stored in the temporary buffer 36.

Moreover, regardless of whether or not the print job J satisfies the conditions, even when an error occurs during the printing process, the association part 37 associates the print job J stored in the temporary buffer 36 with the device status information S obtained by the device status information obtaining part 32 and causes the storage part 31 to store the associated print job J and device status information S as history information.

The conditions stored in the condition storage part 34 include at least one selectable factor in the print job J which is requested from a user to the printer 10.

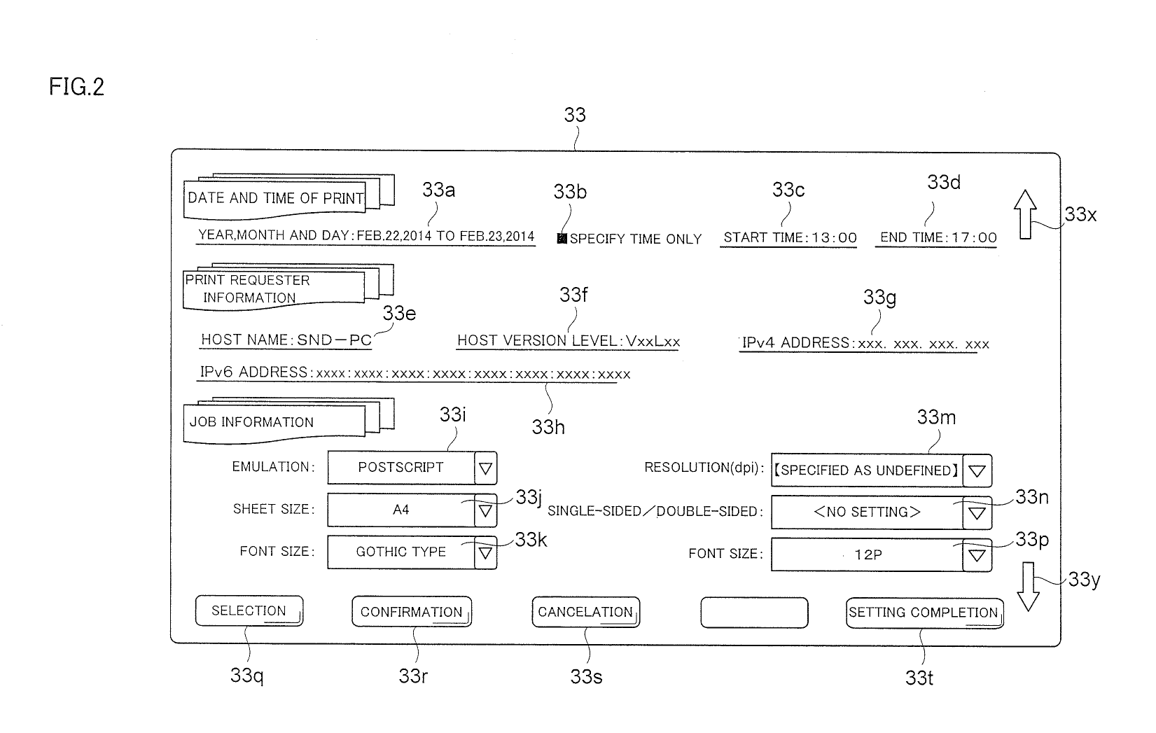

FIG. 2 is a diagram showing an example of a screen for setting conditions displayed in the accepting part 33. The accepting part 33 is formed by, for example, a touch-type operation panel, and as shown in FIG. 2, a screen for setting (inputting) conditions to be selected by a user is displayed thereon. It should be noted that FIG. 2 is an example of a setting screen for conditions corresponding to a case where a so-called cut sheet is applied as the sheet 200 subjected to printing by the printing part 26.

The factors selectable in the accepting part 33 are information available in data communication and items specifiable at a level of a command that supports each PDL (Page Description Language) (print requester information that identifies a print requester, print instructions, print data and the like). Specifically, as shown in FIG. 2, these factors are capable of applying year, month and day 33a of condition determination, a start time 33c of condition determination and an end time 33d of condition determination as date and time information for condition determination.

Here, when year, month and day 33a of condition determination is not set as a condition, a check box 33b time only may be checked as shown in FIG. 2. When the check box 33b time only is checked, year, month and day 33a of condition determination is displayed in an inactive state that is not able to be set as a condition.

On the other hand, when the check box 33b time only is not checked, year, month and day 33a of condition determination is also displayed in an active state that is able to be set as a condition.

In this example, the check box 33b time only is checked, and conditions of 13:00 for the start time 33c of condition determination and 17:00 for the end time 33d of condition determination are set.

Moreover, as print requester information that is the factor selectable in the accepting part 33, a host name 33e of the print requester, a version level 33f of the host, an IP address (v4) 33g of the host and an IP address (v6) 33h of the host can be applied. In the example shown in the figure, as the host name 33e, “SND-PC” is set as a condition.

Moreover, as the print instructions and the print data that are the factors selectable in the accepting part 33, a type of emulation 33i in the print job J, a sheet size 33j, a font type 33k, a resolution 33m, distinction between single-sided printing and double-sided printing 33n, a font size 33p and the like can be applied. In the example shown in the figure, PostScript as the type of emulation 33i, A4 as the sheet size 33j, Gothic type as the font type 33k and 12 points as the font size 33p (in FIG. 2, indicated as “12p”) are set as the conditions.

In the exemplary embodiment, in each of from the type of emulation 33i to the font size 33p, options are set in advance, and the options are displayed in a pull-down menu by pressing an inverted triangular mark.

It should be noted that, in the accepting part 33, there are displayed a selection button 33q for selecting conditions (factors) to be selected, a confirmation button 33r for confirming the selected conditions, a canceling button 33s for canceling the selection and a setting completion button 33t for storing the setting for the selected conditions in the condition storage part 34.

Moreover, an up arrow mark 33x and a down arrow mark 33y displayed in an upper portion and a lower portion, respectively, on the right side portion shown in the setting screen indicate existence of a screen for setting other conditions in a region hidden above and a region hidden below the setting screen shown in the figure, respectively. Then, by touching the up arrow mark 33x, the setting screen is scrolled down, to thereby cause the setting screen hidden above to appear. On the other hand, by touching the down arrow mark 33y, the setting screen is scrolled up, to thereby cause the setting screen hidden below to appear.

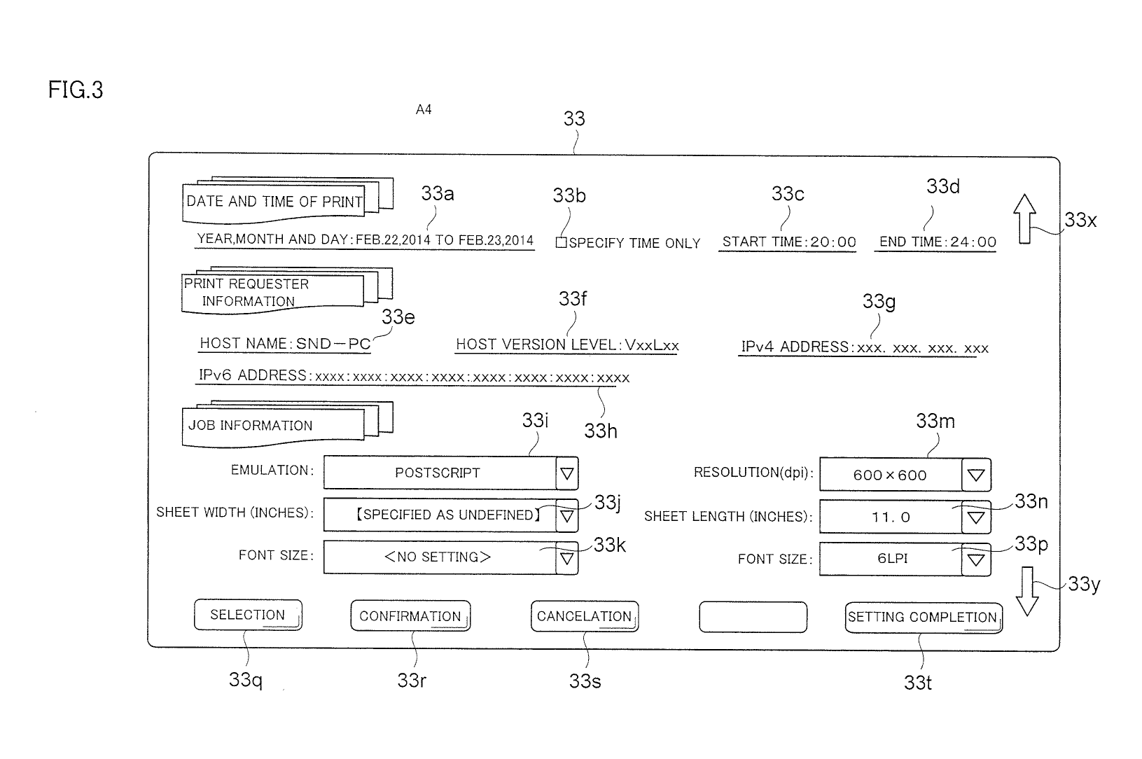

Similar to FIG. 2, FIG. 3 is a diagram showing another example of the screen for setting conditions displayed on the accepting part 33. FIG. 3 is an example of a setting screen for conditions corresponding to a case where a so-called continuous sheet is applied as the sheet 200 subjected to printing by the printing part 26. Most of the conditions displayed on the setting screen in a case where the continuous sheet is applied are the same as the conditions displayed on the setting screen shown in FIG. 2, however, it is possible to set conditions of a sheet width 33u instead of the sheet size 33j (refer to FIG. 2) and a sheet length 33v instead of distinction between single-sided printing and double-sided printing 33n (refer to FIG. 2).

In this example, the check box 33b time only is not checked, and a period from Feb. 22, 2014 to Feb. 23, 2014 is set in year, month and day 33a of condition determination as a condition. Moreover, 20:00 and 24:00 are set as the conditions in the start time 33c of condition determination and in the end time 33d of condition determination, respectively, and existence of the print job J that is compliant with the set conditions is monitored only during the period from 20:00 to 24:00.

As the host name 33e, “SND-PC” is set as a condition, and as the version level of the host 33f, VxxLxx is set as a condition.

Further, PostScript as the type of emulation 33i, 600×600 as the resolution 33m, 11.0 inches as the sheet length 33v and 6 LPI as the font size 33p are set as the conditions.

### <Operations of Printer 10>

Next, operations of the printer 10 of the exemplary embodiment will be described. FIGS. 4-1 and 4-2 are flowcharts showing the operations of the printer 10.

As shown in FIGS. 4-1 and 4-2, first, the interface part 21 (refer to FIG. 1) waits for receipt of the print job J from the large-sized computer 110 or the client PC 120 (51), and when the print job J is received (Yes in S1), the print job J having been received is temporarily stored in the receiving buffer 22 (S2).

Next, the emulation analysis part 23 analyzes the emulation of the print data in the print job J stored in the receiving buffer 22 (S3), transmits the print job J (intermediate data prior to the emulation analysis) to the temporary buffer 36, and causes the temporary buffer 36 to store the print job J (S6) and transmits the print job J to the page development processing part 24, together with the result of analysis of the emulation, for executing the printing process corresponding to the print data in the print job J. The page development processing part 24 converts the print data into the bitmap image data, and develops the data onto the bitmap memory (S11), and thereby printing is executed in the printing part 26 (S13).

On the other hand, in parallel with the analyzing process of the emulation by the emulation analysis part 23, the determination part 35 determines whether or not the print job J satisfies the conditions stored in the condition storage part 34 (S3 to S5). At this time, the determination part 35 first confirms whether or not the conditions to be referred to are set in the condition storage part 34 (S4), and when the conditions are set (Yes in S4), determines whether or not the print job J satisfies the conditions that have been set (S5).

When the print job J is determined to satisfy the conditions that have been set in advance (Yes in S5), the determination part 35 executes the page development processing (S11), which is a flow of the printing process. Further, the determination part 35 issues an instruction to the association part 37 to retain the print job J stored in the temporary buffer 36. With this instruction, the determination part 35 also issues an instruction to the association part 37 to associate the device status information S obtained by the device status information obtaining part 32 with the retained print job J, to thereby cause the storage part 31 to store the associated print job J and device status information S as history information during the period until printing of the image of the print job J in the printing part 26 is completed (S7).

The print data in the print job J transmitted to the page development processing part 24 is converted into the bitmap image data, and thereafter, printed by the printing part 26 (S13). It should be noted that a process in a case where an error (an abnormal operation) occurs in the printing process will be described later.

During the processes from the emulation analyzing process in the emulation analysis part 23 to the completion of printing of the image corresponding to the print job J in the printing part 26, the device status information S indicating the statuses of the emulation analysis part 23, the page development processing part 24 and the printing part 26 is obtained by the device status information obtaining part 32.

By the instruction from the determination part 35, the association part 37 waits until the device status information obtaining part 32 obtains the device status information S for executing the process of associating the device status information S with the print job J (S8). Then, after the device status information obtaining part 32 obtains the device status information S (Yes in S8), the association part 37 associates the print job J stored in the temporary buffer 36 with the device status information S obtained by the device status information obtaining part 32 (S9), and causes the storage part 31 to store the print job J and the device status information S associated with each other as the history information (S10), and thereby a storing process of the history information is completed.

On the other hand, in the printing process when the determination part 35 determines in step 4 (S4) that the conditions to be referred to are not set in the condition storage part 34 (No in S4), when the determination part 35 determines in step 5 (S5) that the print job J does not satisfy the set conditions (No in S5), or when results in both step 4 and step 5 are Yes, the page development processing part 24 converts the print data in the print job J into the bitmap image data based on the result of emulation analysis and the print job J, and develops the bitmap image data obtained by conversion onto the bitmap memory 25 (S11).

When the process is completed without occurrence of an error (an abnormal operation) in the conversion process in the page development processing part 24 (No in S12), the bitmap image data developed on the bitmap memory 25 is transmitted to the printing part 26.

The printing part 26 prints the image corresponding to the bitmap image data developed on the bitmap memory 25 onto the sheet 200 according to specifications identified by the print job J (S13). When the process is completed without occurrence of an error (an abnormal operation) in the printing process in the printing part 26 (No in S14, then S15), the association part 37 deletes each of the print job J stored in the temporary buffer 36 and the print job J stored in the receiving buffer 22 (S16), and finishes the process.

When an error (an abnormal operation) occurs in the conversion process in the page development processing part 24 (Yes in S12), or when an error occurs in the printing process in the printing part 26 (Yes in S14), the association part 37 issues an instruction so that the association part 37 associates the print job J stored in the temporary buffer 36 with the device status information S and causes the storage part 31 to store the associated print job J and device status information S by the control of the association part 37(S17).

Moreover, the determination part 35 issues an instruction to the association part 37 to associate the device status information S obtained by the device status information obtaining part 32 with the retained print job J and to cause the storage part 31 to store the associated print job J and device status information S as the history information during the printing process. The association part 37 complies with the instruction and waits until the device status information obtaining part 32 obtains the device status information S (S18). Then, after the device status information obtaining part 32 obtains the device status information S (Yes in S18), the association part 37 associates the retained print job J with the device status information S obtained by the device status information obtaining part 32 (S19), and causes the storage part 31 to store the associated print job J and device status information S as the history information (S20).

After causing the storage part 31 to store the associated print job J and device status information S, the association part 37 deletes the print job J stored in the temporary buffer 36 (S21), handles the error having occurred (S22), and finishes the process.

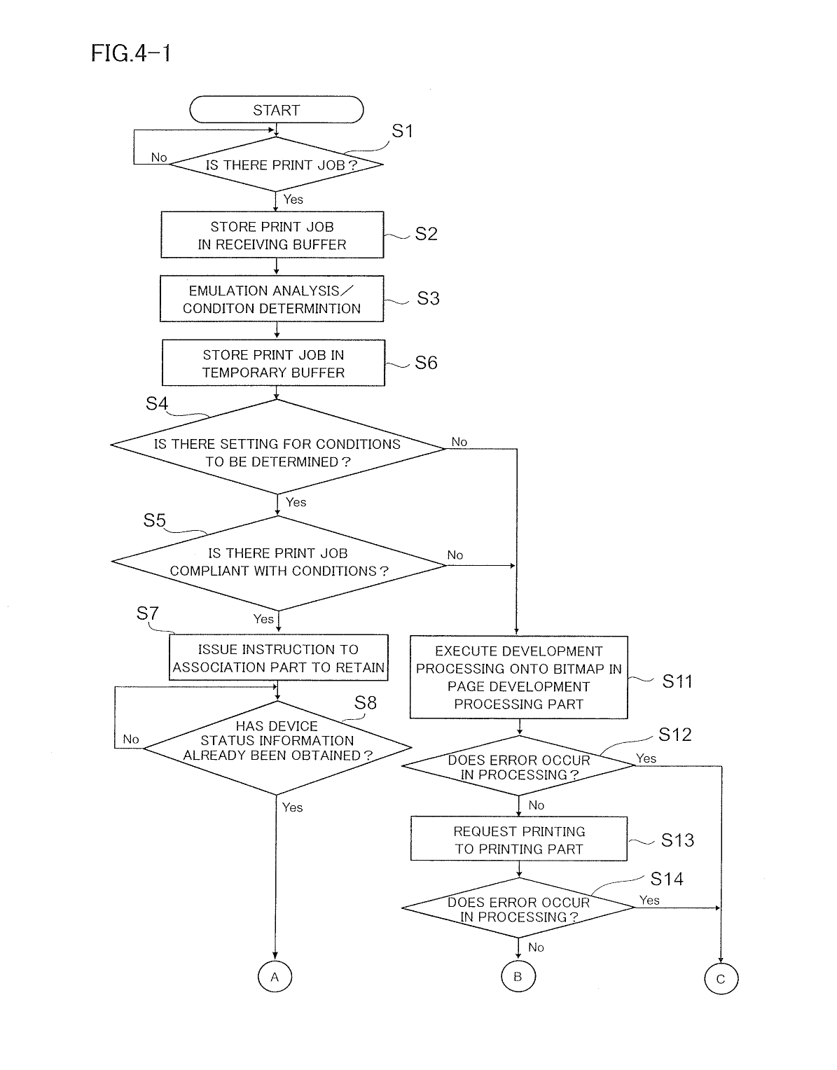

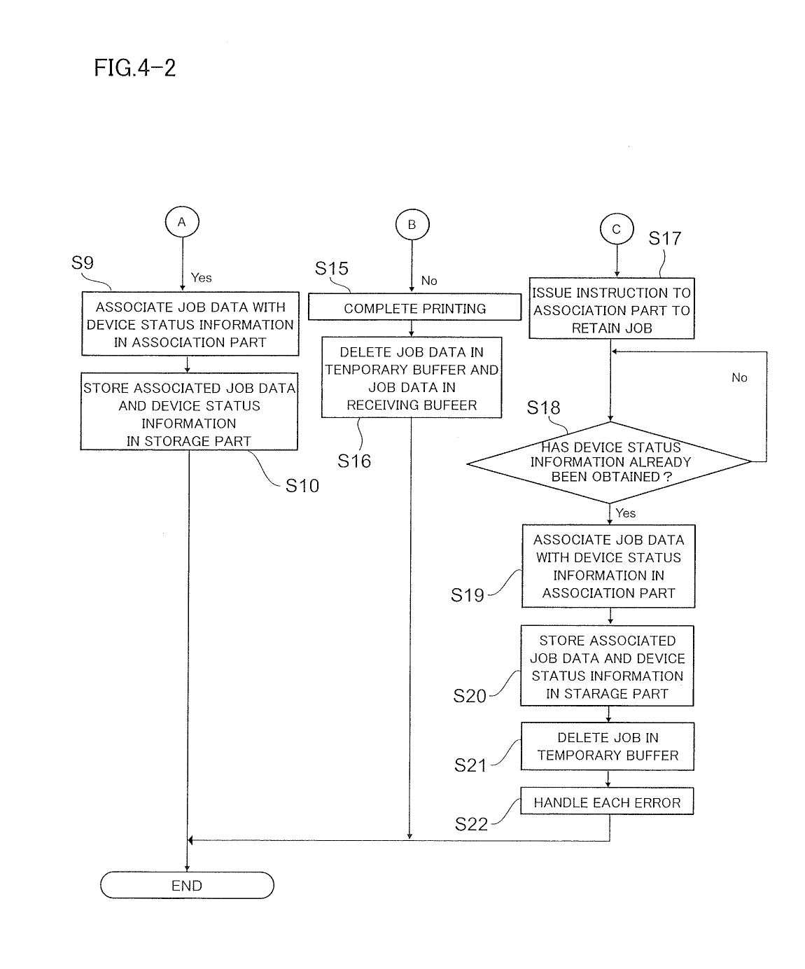

As described above, according to the history storage device 50 and the printer 10 of the exemplary embodiment, regardless of whether or not an error occurs in the printing process, when the print job J satisfies specific conditions (Yes in S5 of FIG. 4-1), the print job J and the device status information S obtained in the printing process of the image corresponding to the print data in the print job J are associated with each other and stored in the storage part 31 (S10).

Consequently, when a printing result not intended by a user occurs in a printing process of an image corresponding to a print job J satisfying specific conditions, in inquiring a cause of such a printing result, the print job J and the device status information S associated with each other and stored in the storage part 31 are able to be used as useful information.

In other words, also in a case where operations not regarded as an error in the printing process, such as garbling of characters, occur, since the history information, in which the print job J and the device status information S are associated with each other, is stored in the storage part 31, it is possible to identify the cause of occurrence of the error or to narrow potential causes of occurrence of the error by the stored history information.

Moreover, since the history storage device 50 and the printer 10 of the exemplary embodiment store only the print job J that satisfies the conditions having been set and the device status information S in the storage part 31, it is possible to suppress the size of the storage region of the storage part 31 required for storing, compared to those store all print jobs J and device status information S in the storage part 31 without setting any condition.

Since, even when an error occurs in the printing process, the association part 37 associates the print job J with the device status information S in the printing process of the image corresponding to the print job J and causes the storage part 31 to store the associated print job J and the device status information S (Yes in S12 and Yes in S14 of FIG. 4-1), the history storage device 50 and the printer 10 of the exemplary embodiment are able to store the associated print job J and the device status information S as useful information for inquiring a cause of the error and utilize the information, even in a case where the print job J does not satisfy specific conditions.

Moreover, according to the history storage device 50 and the printer 10 of the exemplary embodiment, since, separately from the print job J used in the printing process (the print job J transmitted to the page development processing part 24), a print job J to be associated and stored can be stored in the temporary buffer 36, it is possible to store the history information in parallel with the printing process for an image corresponding to the print job J.

Further, according to the history storage device 50 and the printer 10 of the exemplary embodiment, since the print job J and the device status information S are associated and stored in the storage part 31, and thereafter the print job J stored in the temporary buffer 36 is deleted, it is possible to prevent the storage region of the temporary buffer 36 required to temporarily store the print job J from being reduced.

### <Exemplary Embodiment of Program>

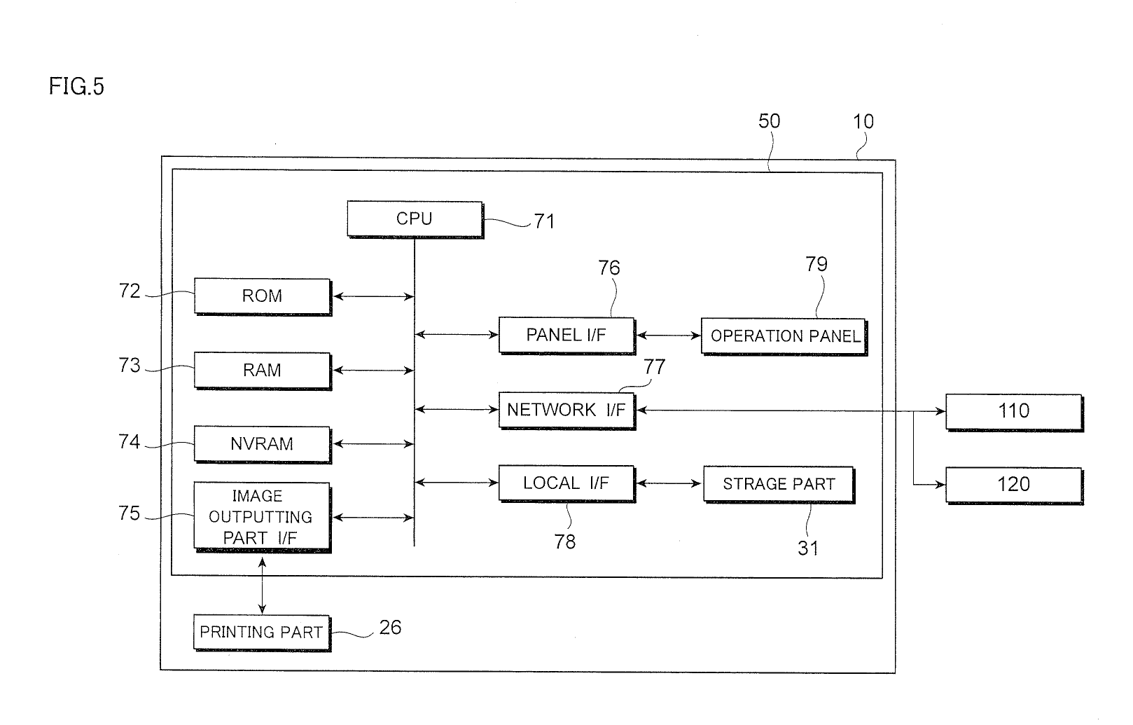

FIG. 5 is a diagram showing an example of a hardware configuration that implements a function of the above-described history storage device 50 by a computer having read a program.

The history storage device 50 is configured with: a CPU (Central Processing Unit) 71; a ROM (Read Only Memory) 72; a RAM (Random Access Memory) 73; an NVRAM (Non Volatile RAM) 74; an image outputting part I/F (image outputting part Interface) 75; a panel I/F (panel Interface) 76; a network I/F (network Interface) 77; a local I/F (local Interface) 78; an operation panel 79; and the storage part 31.

The ROM 72 is storing a program executed by the CPU 71. The CPU 71 reads the program stored in the ROM 72, executes the program in the RAM 73 as a work area, and according to the program, controls operations of the ROM 72, the RAM 73, the NVRAM 74, the image outputting part I/F 75, the panel I/F 76, the network I/F 77, the local I/F 78, the operation panel 79, the storage part 31 and the printing part 26. The NVRAM 74 is a non-volatile memory.

The image outputting part I/F 75 carries out communication of the print data in the print job J, control signals or information with the printing part 26. The panel I/F 76 carries out communication of information with the operation panel 79. The operation panel 79 corresponds to an example of the accepting part 33 in FIG. 1. The network I/F 77 corresponds to the interface part 21 in FIG. 1, and is connected to the large-sized computer 110 or the client PC 120 via communication. The local I/F 78 carries out data communication with the storage part 31.

The program executed by the CPU 71 implements, of the printer 10 including the printing part 26 that forms an image corresponding to a print job J, a function of obtaining device status information S in printing the image, and a function of, when the print job J satisfies preset conditions, associating the print job J with the device status information S obtained in printing the image corresponding to the print job J and causing the storage part 31 to store the associated print job J and the device status information S.

Consequently, the CPU 71 functions as the determination part 35, the association part 37 and the device status information obtaining part 32 in FIG. 1, the RAM 73 functions as the temporary buffer 36, the NVRAM 74 functions as the condition storage part 34, and the operation panel 79 functions as the accepting part 33.

It should be noted that the CPU 71 also functions as the emulation analysis part 23 and the page development processing part 24 in the printer 10 shown in FIG. 1, and the RAM 73 also functions as the receiving buffer 22 and the bitmap memory 25.

With a program configured as described above, actions and effects same as those of the above-described history storage device 50 can also be obtained.

The history storage device 50 and the printer 10 of the above-described exemplary embodiment include the accepting part 33 that accepts input of specific conditions as a constituent; however, the processing device and the image forming apparatus according to the present invention may not include the accepting part 33.

In other words, since, in the processing device and the image forming apparatus according to the present invention, the conditions are only necessary to be specified when an image corresponding to an image forming instruction is formed, after the conditions are temporarily stored in the condition storage part 34, it is unnecessary to include the accepting part 33 unless there is a necessity to change the conditions.

Accordingly, the accepting part 33 may be provided to the external large-sized computer 110 or the client PC 120 connected to the history storage device 50 and the printer 10 via a communication line such as a network, and it may be possible to change the conditions stored in the condition storage part 34 or to newly set conditions in the condition storage part 34 by the accepting part 33 provided to these large sized computer 110 or the client PC 120.

In this case, it is possible to change the conditions to be stored in the condition storage part 34 even by the large-sized computer 110 or the client PC 120 distant from the history storage device 50 and the printer 10.

The above-described exemplary embodiment applies the printer 10 as an example of an image forming apparatus; however, the image forming apparatus according to the present invention is not only limited to a printer, but an image forming apparatus of an embodiment other than the printer can be applied as long as the apparatus forms an image corresponding to an image forming instruction (an image formation job such as a print job).

The program that achieves the present exemplary embodiments may be provided not only by a communication unit but also by being stored in a recording medium such as a CD-ROM.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The exemplary embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A history storage device connected to an image forming apparatus including an image forming part that forms an image corresponding to an image forming instruction and a device status information obtaining unit that contains device status information, the history storage device comprising:
a storage part in which the image forming instruction and the device status information obtained by the device status information obtaining unit when the image corresponding to the image forming instruction is formed are associated with each other and the associated image forming instruction and device status information are stored, when the image forming instruction satisfies a preset condition,
wherein the device status information includes at least one of information that specifies a state of consumption of a consumable part such as toner, information that specifies a state of detection of each mechanical sensor, and information that specifies each setting state on a mechanical side.

2-16. (canceled)

17. The history storage device according to claim 1, wherein the image forming instruction includes print data that is image data or is capable of being converted into image data.

18. The history storage device according to claim 1, wherein, when the condition is occurrence of an abnormal operation in the image forming apparatus in forming an image, the image forming instruction and a state of detection of a mechanical sensor detecting the abnormal operation in forming the image corresponding to the image forming instruction are associated with each other, and the associated image forming instruction and state of the detection of the mechanical sensor are stored.

19. A history storage device connected to an image forming apparatus including an image forming part that forms an image corresponding to an image forming instruction and a device status information obtaining unit that obtains device status information, the history storage device comprising:
a storage part in which the image forming instruction and the device status information obtained by the device status information obtaining unit when the image corresponding to the image forming instruction is formed are associated with each other and the associated image forming instruction and device status information are stored, when the image forming instruction satisfies a preset condition, wherein
the image forming instruction includes print data that is image data or is capable of being converted into image data, and
the condition is changeable by input accepted by an accepting part of another apparatus that is connected to the image forming apparatus via a communication line and is different from the image forming apparatus.

20. The history storage device according to claim 1, wherein an accepting part that accepts input of change of the condition is not included.

21. A history storage device connected to an image forming apparatus including an image forming part that forms an image corresponding to an image forming instruction and a device status information obtaining unit that obtains device status information, the history storage device comprising:
a storage part in which, in response to the image forming instruction satisfying a preset condition, the image forming instruction and the device status information obtained by the device status information obtaining unit when the image corresponding to the image forming instruction is formed are associated with each other and the associated image forming instruction and device status information are stored only when the image forming instruction satisfies the preset condition, wherein
the image forming instruction includes print data that is image data or is capable of being converted into image data.
